(19) United States
(12) Patent Application Publication
(10) Pub. No.: US 2005/0234809 A1
(43) Pub. Date: Oct. 20, 2005

(54) Optimized control system for portfolios of managed futures

(76) Inventor: Oscar H. Criner, Houston, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 11/108,265

(22) Filed: Apr. 18, 2005

Related U.S. Application Data
(60) Provisional application No. 60/563,097, filed on Apr. 16, 2004.

(51) Int. Cl. G06F 17/60

(52) U.S. Cl. 705/37

(57) ABSTRACT

Provided is a method that, given a price-time trajectory, seeks the policies that optimize portfolio performance over that trajectory. The claimed subject matter provides the result of a program of research that succeeded in that effort. The disclosed control theoretic approach: 1) develops a measure of profitability of the trading portfolio; 2) computationally models the trading process operating on the price-time histories; 3) calculates estimates of the price-time histories using functions with well-known mathematical characteristics; 4) calculates, using the calculated estimates, derived functions of the price-time histories about which control variables are known and about which there is a priori knowledge; and 5) simulates, using the derived functions, the trading policies and seek the values of the control variables that maximize the portfolio's trading performance over the life of the trading instruments.

### CROSS-REFERENCE TO RELATED APPLICATIONS

The present application is related to and claims the benefit of the filing data of the following provisional application with a common inventor, which is hereby incorporated by reference:
U.S. Provisional Patent Application Ser. No. 60/563,097 (Attorney Docket Number CRNR001USP), filed Apr., 16, 2004, titled “Optimized Control System for Portfolios of Managed Futures.”

### TECHNICAL FIELD

The present invention relates generally to a financial management system and, more specifically, to a method for managing portfolios of managed futures.

### BACKGROUND OF THE INVENTION

The search for the “Holy Grail” of stock and futures trading tempts one to invoke the prayer described by the philosopher F. S. C. Northrup in The Logic of the Sciences and the Humanities:
Were a benign and omnipotent being to appear before the vast body of creative contemporary economists, in religious fever assembled, promising the answer to one request, the prayer offered up would probably be as follows: Most Needed and Welcome being, give us a scientific theory of economic dynamics.[1]
   What should the structure of such a theory be?

The growth of trading of derivative instruments, formally and informally, has significantly increased in the last quarter of the twentieth century The complexity and misunderstanding of derivative instruments has also exposed a great deal of risk and loss. As financial markets become more and more complex and participation in market activity becomes broader in the population, the perception of the market must also change from the closed purview of a relatively small group of traders to a truly global market with literally hundreds of millions of participants. As electronic exchanges expand to developing countries around the world, many more markets will become active on a twenty-four hour basis. As more and more people are involved in the markets, the more deterministic the markets will become.

Contemporary investors and traders today have an extremely fast growing digital information infrastructure encompassing almost all of the formal financial markets. Formal markets include open outcry and electronic markets where standardized contracts or instruments are traded and records of each transaction are maintained in an electronic format. These markets have experienced tremendous growth during the last half of the twentieth century that would have been impossible without the development of computing and communications technologies. Everyday there is generated an enormous amount of data on the prices, volumes, and, where applicable, the open interest in actively traded markets. However, the conceptualizations of what to do with all these data are essentially extensions of the work of Charles Dow in the late nineteenth century.

What is needed is a system that, given only historical trading price-time data for the formally traded financial instrument of interest (portfolio), trading decisions can be made at the current point in time so that the chosen performance measure of the portfolio is maximized.

### SUMMARY OF THE INVENTION

Advancing computing technology has encouraged development of an extremely large number of computational tools to solve this problem. Most of these tools employ pattern recognition, moving averages, or neural nets. Few, if any, attempts have been made to cast the problem into a single consistent theoretical framework. We use the theory of optimal control of differential equations as the framework and seek an inverse solution for the controller. Given a price-time trajectory, we seek the policies that optimize performance over that trajectory. Assuming that the behavior continues into the future for some time, the optimal control strategies are the result. The claimed subject matter provides the result of a program of research that succeeded in that effort. The disclosed control theoretic approach is to: 1) develop a measure of profitability of the trading portfolio, 2) computationally model the trading process operating on the price-time histories, 3) calculate estimates of the price-time histories using functions with well-known mathematical characteristics, 4) calculate, using the calculated estimates, derived functions of the price-time histories about which control variables are known and about which there is a priori knowledge, 5) simulate, using the derived functions, the trading policies and seek the values of the control variables that maximize the portfolio's trading performance over the life of the trading instruments. A realizable optimal control strategy is a direct extrapolation of the optimal simulation of trading into the future, day by day.

We describe an approach that is motivated by the ideas of modern systems engineering and the principles of optimal control of processes. This approach is holistic and includes both technical and fundamental analyses, in the sense that both the physical data on the production, supply, storage, transport, and utilization of a commodity as well as the price-time histories of its trading activity.

No assumptions about form of the mathematical models of the market are made. This enables lets the market data determine the kinds of analytical tools that are applicable. The example given is limited to trading a portfolio of futures so as to achieve consistent profitability, i.e., the speculators problem. Market analysis is a process that depends on our conceptualization of what the market is and how it behaves. If we assume that market prices movement is random in its behavior, then we seek to apply the tools of probability, statistics, and stochastic processes. If we assume that the market behavior is deterministic, then we seek to use paradigm of the control of dynamic processes. These several views of the market processes and the search for techniques for the valuation of trading assets have stimulated an endless pursuit of mathematical models of market processes. The efficient market hypothesis and the idea of the random walk described in Bodie [2] has been the dominant theoretical construct for almost a half-century. This view is loosing favor as empirical studies have been conducted that cast doubt on the efficient market hypothesis and suggest that a strong causal component exists in market behavior. [3] We take this latter view and believe that the determinism in the markets can be isolated in many individual cases. This result appears to be demonstrated in our research, as each market requires its own unique computational model. There are instances where the controls of the computational model are unique to the particular trading instrument within a given market. Some markets behave better than others and are amenable to our techniques and still others defy us completely.

### BRIEF DESCRIPTION OF THE DRAWINGS

A better understanding of the present invention can be obtained when the following detailed description of the disclosed embodiments is considered in conjunction with the following drawings, in which:

FIG. 1 is a graph of an exemplary mean of the S&P 500 Index Futures plotted with the mean smoothed with a polynomial filter with end point corrections.

FIG. 2 shows a graph of the dataset of the graph of FIG. 1 with the dataset filtered with the first derivative of the smoothed data.

FIG. 3 is a graph of the first and second derivatives of the smoothed data of FIGS. 2 and 3.

FIG. 4 is a chart illustrating an exemplary monthly profit, loss, net profit and net asset value for a portfolio of one contract of each stock index futures.

FIG. 5 is a table showing the composition of the stock index portfolio of FIG. 4 with a percentage gain over the entire period of a simulation.

FIG. 6 is a chart illustrating a monthly profit, loss, net profit and net asset value for a portfolio of one contract of an exemplary currency market.

FIG. 7 is a table showing the composition of the currency market portfolio of FIG. 6 with a percentage gain over the entire period of the simulation.

FIG. 8 is a flowchart of a Setup Procedure process that is one, exemplary implementation of the claimed subject matter.

### DETAILED DESCRIPTION OF THE FIGURES

Although described with particular reference to stock and currency markets, the claimed subject matter can be implemented in trading system in which predictions of market movement is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

Optimal control theory requires that a problem be stated in terms of the fundamental principles of the control paradigm to enable computational modeling and simulation to be effective. [4] It is important to know how and why the computational model works from a scientific and mathematical point of view.

First we develop a measure of performance of the system being modeled and for which an extremum, i.e., a maximum or a minimum, is sought. That measure is, of course, profitability; call it P. Second, express or “model” the profitability, P, in terms of relations, functions, functionals, or processes of the system's observables about which some fundamental knowledge applies. The profitability is the sum of the profit or loss of trades of an instrument over the trading history up to the present; summed for all instruments in the portfolio. Here the term “fundamental knowledge” includes the classical fundamental analysis of the futures industry in addition to the “fundamental first principles” of the applicable mathematics, science, and engineering. The “observables” price time histories of trading activity plus other published data. Third, computational algorithms are applied to calculate filtered estimates of the price time histories and approximate them with functions from a set of known functions with well-known mathematical characteristics. These filtered estimates are used to calculate other characterizing functions of the price time histories about which the behavior of control variables are known. Fourth, using the filtered estimates, values of the control variables are chosen that modify the computational model's performance over the past life of the trading instrument. Finally, those filtered estimates and control values that yield the maximum value for the portfolio up to the current time are the optimal strategies for the portfolio. This extremum is obtained through a sequence of applied simulation runs of trading scenarios applied to the life of the trading instrument.

Mathematical Considerations

Most of the mathematical machinery that has been used to investigate issues of trading management is based upon the assumption that the market processes are linear. Here we make no assumption on the form of the dynamic systems. We assume that the market produces continuous time series of prices of the instruments that we wish to trade. This time series is directly observable and we assume the time series x(t) is a continuous function of the variable t on the closed interval [tᵢ, tⱼ], for some i, j with i≠j. The interval may extend over several days or months. A portfolio is a set X of futures contracts xᵢ(t) for i=1, . . . n, for some integer n. Each futures contract x₁(t) is traded only for a specific interval of time, say [t^{b},t^{f}], where t^{b} is the beginning date and t^{f} is the ending date of trading of a futures contract. Each contract in a futures portfolio may have different beginning and ending dates of trading.

The development of trading for 24 hour a day in many markets makes the assumption of continuous market data a possibility. These data can be sampled at different times during the trading day with many different sampling schemes. The schemes that we use conform to the standard Dow-Jones format but it is not necessary to do so. For our purposes, we need only to have a good estimate of a mean and median price during the trading day and a price at which execution is possible. In this scheme we take t^{o} and t^{c} to be the opening and closing times of trading of futures on day t, so that x(t^{o}) and x(t^{c}) are the opening and closing prices of futures contract x(t), respectively. Two other values are sampled, x^{h}=max{x(τ)} and x^{l}=min{x(τ)} for τε[t^{o},t^{c}].

We define the daily mean price, \overline{x}=(x(t^{o})+x^{h}+x^{l}+x(t^{c}))/4 and the daily median price, \tilde{x}=(x^{h}+x^{l})/2, used to compute characterizing estimates of the daily trading prices that are the basis for the computational model of the decision process. We assume that x(t) has an additive component of random noise and we write x(t)=y(t)+n(t), where n(t) is the noise component that can be removed by linear filters and y(t) is the deterministic component.

We assume that for a deterministic process that there exists a vector function F(τ, y, y′, y″, u) such that the vector differential equation F(t, y(t), y′(t), y″(t), u(t))=0 has y(t) as a solution and u(t) as a forcing or control function. We define a portfolio X={x₁(t),x₂(t), . . . ,xₙ(t)} as a set of n futures contracts with price time histories xᵢ(t), beginning trading date tᵢ^{b}, and ending trading date tᵢ^{f}. If F(t,y(t),y′(t),y″(t),u(t))=0 is a continuous function differentiable in its variables, then we can write the vector differential equation

$$\frac{ⅆ {y}_{i} ( t )}{ⅆ t} = {f}_{i} ( t , {y}_{i} ( t ) , {u}_{i} ( t ) ) = {y}_{i}^{′} ( t ) ,$$

where for each portfolio component i, the values of the solution of this differential equation is yᵢ(t). The form of the function fᵢ(τ,y,u) is not known nor is it required, since we have the values of yᵢ(t). We now find polynomials pᵢ(t) that track each yᵢ(t) as close as we please and then to find the derivatives p′(t) and p″(t) that we assume will approximate the derivatives of yᵢ(t). We then seek the trading policy or set of controls that maximize the profitability of the portfolio, X. The profitability P(X) is

$$P ( X ) = {\sum }_{i = 1}^{n} {\sum }_{α}^{α + β} χ ( {t}_{α + β} , {t}_{α} ) ( {x}_{i} ( {t}_{α + β}^{c} ) - {x}_{i} ( {t}_{α}^{c} ) ) φ ( i )$$

where a is a multi-index of position entry dates, β is the corresponding multi-index of position exit dates, χ(t_{α+β}, t_{α})is a characteristic function, (χ(t_{α+β}, t_{α})=1 if t_{α+β}≧t_{α}or χ(t_{α+β}, t_{α})=−1 if t_{α+β}<t_{α}) and φ(i)is the contract value per point of the i^{th} portfolio component. Our problem is to maximize P(X).

In this case yᵢ(t) is not known to be twice differentiable, however, we will assume that it is at least sectionally continuous on a closed time interval. Although we do not know the functional form of the mathematical model for yᵢ(t), we do know that the polynomial pᵢ(t) approximating y₁(t) as close as we please can be found. This means that the polynomial pᵢ(t) will have the same frequency response characteristics as yᵢ(t) on the interval on which it is defined. As an element in the space of continuous functions yᵢ(t) can be approximated by polynomials with continuous first and second derivatives defined on the closed time interval [tₐ,t_{b}]. For these polynomials, the time rate of change of yᵢ(t) is approximated by the time rate of change of pᵢ(t).

In fact, we do not need the actual polynomial coefficients since the formula is not necessary in our computational approach.

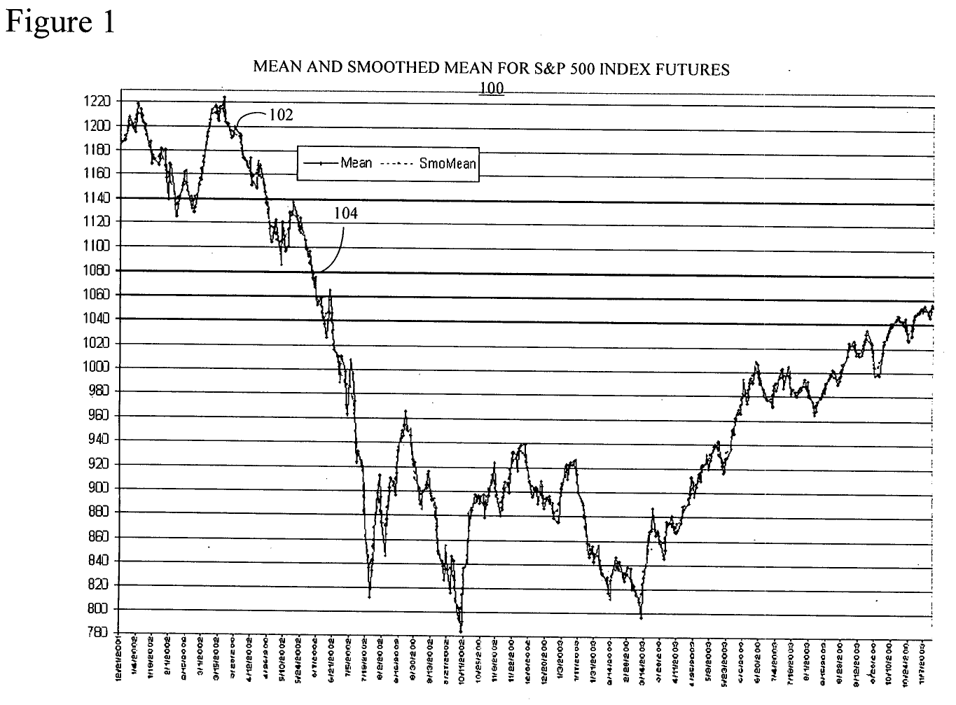

Turning now to the figures, FIG. 1 shows a graph 100 of the mean 102 of the S&P 500 Index Futures plotted with the mean smoothed 104 with a polynomial filter with end point corrections. A solid line represents mean 102 and a dotted line represents the smoothed mean 104. End point corrections guarantee that the smoothed function will be in phase with the original data, i.e., the smoothed function does not lag behind the data. The 3-point moving average is an example of a 3-point linear least squares polynomial filter.

The smoothness of the filter is increased with the length and iteration of the filter and decreased with the degree of the polynomial used to construct the filter. Higher degree polynomial filters follow the variations in the data very closely.

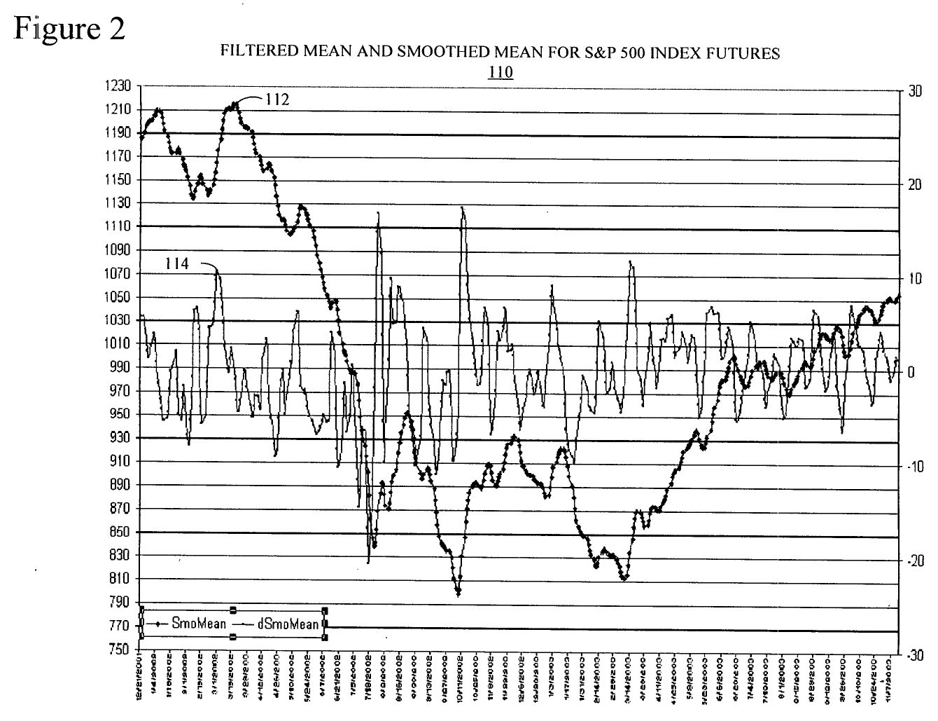

A discussion of the theory of least squares polynomial filters is given in Hildebrand [5]. FIG. 2 shows a graph 110 of the dataset of graph 100 (FIG. 1) with the dataset filtered with the first derivative of the smoothed data. A dotted line represents the filtered mean 112 and a dotted line represents the filtered, smoothed data 114.

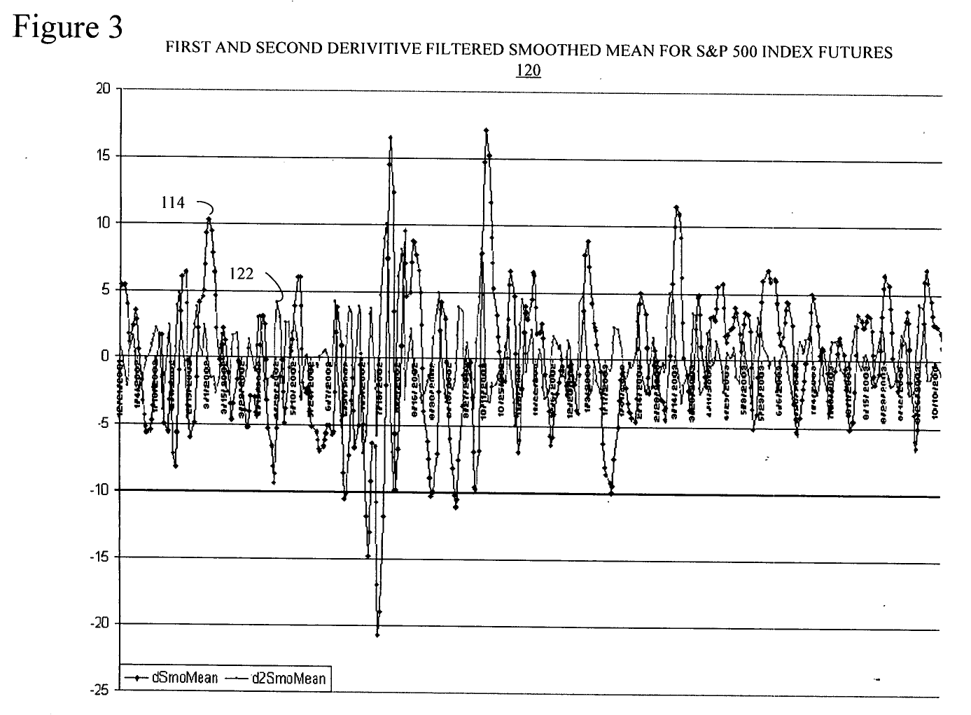

FIG. 3 is a graph 120 of the first derivative 114 (FIG. 2) and second derivatives 122 of the smoothed data. Further p′(t) and p″(t) approximate y′(t) and y″(t), respectively, in the same manner. We compute these derivatives of p(t) with a differentiating filter that is also fitted with the endpoint correction, so that the derivatives are computed up to the boundary of the time interval.

The problem can now be formulated as an “inverse” control problem, i.e. to find the control functions that constrain the given solutions to maximize the performance of the decisions.

Buy Low and Sell High Implemented by an Innovative Technique

The old traders adage “buy low and sell high” has been a teaser for years because of the difficulty of implementation. Tools and techniques for prediction are improving such that even the weather is predictable. Markets are predictable also and we begin with a first stage analysis required for prediction. First we need to state what we are and are not trying to predict. We are not trying to predict the prices of the time series xᵢ(t). For the managed futures portfolio, the prediction of the prices is unimportant. We need only estimate the rates of change, p′ᵢ(t) and p″ᵢ(t); and those estimates are needed for each trading day τ in a small left-side neighborhood of the present time, i.e., τ≦t, where tᵢ^{b}≦τ≦t≦tᵢ^{f}. For each trading day t we create a pushdown table to partition a portion of the interval [t_{b},tᵢ] in to ν+1 points {t_{-ν}, t_{-ν+1}, . . . ,t₋₁, t₀=tᵢ}. This pushdown table is used to compute the values of pᵢ(τ), p′ᵢ(τ), and p″ᵢ(τ) for t_{-ν}≦τ≦t₀. Clearly, the values at the near time end point t₀ are the most important. If trading begins at t₀, then for the next trading day the push down table will be {t_{-ν+1}, t_{-ν+2}, . . . , t₋₁, t₀, t₁=tᵢ}. Ignoring weekends and holidays, this procedure results in a sequence of functions that are different each day. The function p_{i,0}(t) that approximates yᵢ(t) on [t_{-ν},t₀] is different from the function p_{i,l}(t) that approximates yᵢ(t)on [t_{-ν+1},tₗ]. In fact ν is small and needs only to be large enough to permit calculation of pᵢ(τ), p′ᵢ(τ), and p″ᵢ(τ) at the end point of the interval τ=t_{κ}. The time series of end-point values generated by this process is substantially different from yᵢ(t) although it might be difficult to observe. This time series of states of the portfolio is calculated independently for each trading day and is not simply a continuation of an averaging process.

Suppose make the analogy of the portfolio X with the state S of a space ship that we are required to keep on a trajectory. Then as in the control of space flight, each state contains values of the position, velocity, and acceleration of the system, and the differential equations of motion. We then we apply a “bang-bang” control based upon these states to achieve the control objective. Suppose the rocket is constrained to a two-dimensional space then we can control pitch by firing two rockets, switching one for up and one for down, hence the term “bang-bang.” We will ignore roll and yaw. In this control scenario, the equations of motion and the initial value problems provide the trajectory.

A more complex control problem is the maneuverable air-to-air missile-targeting problem. This problem is to follow a target g(t) with a function r(t) as close as possible and to intercept the target, g(t)=r(t), at some time t. Clearly, no model is available for the function g(t), it is only known by measurement up to the present. The general class of tracking problems is to follow some desired state r(t) throughout the interval t₀≦t≦tₗ. Systems with this characteristic are simple servomechanisms and if r(t) is a constant it is called a regulator. In this case the trajectory of the target

Now we conceptualize the portfolio trading problem as a one dimensional flight control of a space ship, where we are only concerned with following the trajectory very closely and applying a “bang-bang” switching control, i.e., bang, buy or bang, sell. The simulation process is to optimize the trading performance on every subinterval of length ν+1 in [t_{b},t]. Having optimized the performance on subintervals up to the present time t₀, we then allow the simulation to proceed forward in time. The examples included in this paper have been optimized for the year 2002, and allowed to run unaltered for the year 2003.

Relative Maxima and Minima

From elementary calculus [6] and its theory of maxima and minima we know that: (1) If p is a continuous function defined on a closed interval [tₐ,t_{b}], then there exists at least one point tₕᵢ in [tₐ,t_{b}] where p attains its largest value and there is at least one point tₗₒ where p attains its lowest value. (2) A function p is said to be increasing on an interval (tₐ,t_{b}) if p(t₂)>p(tₗ) whenever t₂>t₁ and both t₁ and t₂ are in (tₐ,t_{b}). It is decreasing if p(t₂)<p(t₁) whenever t₂>t₁. (3) If p′(τ)>0 for each τ in an interval (tₐ,t_{b}), then p is increasing on (tₐ,t_{b}). Similarly, if p′(τ)<0 for each τ in (tₐ,t_{b}), then p is decreasing on (tₐ, t_{b}).

It is further well known that at a maximum or minimum of a function, the first derivative is zero and a point at which the first derivative is zero is called a critical point. The standard tests for determining maxima and minima are as follows:
Test 1(a) If p is increasing (p′>0) in some interval to the left of t₀ with t₀ as endpoint of this interval, and if p is decreasing (p′<0) in some interval to the right of t₀ with t₀ as the endpoint of this interval, then p has a (relative) maximum at t₀.

Test 1(b) If p is decreasing (p′<0) in some interval to the left of t₀ with t₀ as end point of this interval, and if and if p is increasing (p′>0) in some interval to the right of to with to as the endpoint of this interval, then p has a (relative) minimum at t₀.

Test 2 If p has two derivatives and p″ is continuous and t₀ is a critical point (p′(t₀)=0), then (a) if p″(t₀)>0,p has a relative minimum at t₀, (b) if p″(t₀)<0, p has a relative maximum at t₀, if p″(t₀)=0, the test fails.

It is clear that these statements from the calculus assume that we have to as an interior point of some interval. In the application we are considering, to is the right endpoint of the interval so that we have only half of the information in the neighborhood of the boundary. We have only information as we approach the right endpoint from the left side, if time is increasing to the right. But we also have other information, namely that when p″(t₀)=0, to may be a point of inflection of p. If the graph has a point of inflection at t₀, then the graph is going to be either concave upward on one side of t₀ and concave downward of the other or concave downward of one side of t₀ and concave upward on the other. In either case, the point of inflection occurs before the maxima or minima are attained. This means that turning points in the time series can be predicted. Observation of this behavior in the market data confirms that the relative maxima and minima are identified.

We say that p is a monotonic increasing (or strictly increasing) function on an interval when the first derivative is positive (p′>0) on the interval and p is a monotonic decreasing (or strictly decreasing) function on an interval when the first derivative is negative (p′<0) on the interval. We say the p is strongly monotonic where p is increasing and both p′>0 and p″>0. This means that not only is the function increasing strongly, but also the rate of increase is increasing. A similar statement holds for monotonic decreasing functions. The computational model takes advantage of this fact and applying this theory to trading data begins with the identification of strongly monotonic price-time series estimates where p′(τ) and p″(τ) in some interval near each trading day t. The pseudo code for this process is what begins the computational algorithm.

Procedure Trade Recommendations

The pseudo code for this process is what begins the computational algorithm.

Procedure IdentifyTrend

If p′(t) > Zero0 and p″(t) > Zero4

Then Call Up_Trend

ElseIf p′(t) < −Zero0 and p″(t) < −Zero4

Then Call Down_Trend

Else
Call Sideways_Trend
End If

End Procedure

Clearly, Zero0 and Zero4 are parameters that control the invocation the Up_Trend, Down_Trend, or Sideways_Trend procedures. There are several variations of this algorithm as some markets require the strongly monotonic algorithm and in others the monotonic algorithm is effective. Still others require the monotonic algorithm with “bang-bang” acceleration, i.e., they depend only on the sign value (plus or minus) of the acceleration.

Each trend has a separate decision process module in the computational model. Sideways markets are the most complex and have the highest risk because traditional wisdom suggests that positions held through sideways markets almost always loose. The sideways market analysis is more complex than that in either up or down trending markets.

Up_Trend Procedures

The Up-Trend procedure is invoked if the trend is strongly monotonic increasing. If no position is held, then the up-trend process will set the action variable to “buy” to establish a long position and pass that action to the rest of the system. If a short position is held, then the up-trend process will set the action variable to “Buy” to cover the short position. If a long position exists, then Up-Trend evaluates the position to determine if it should be held.

Down_Trend Procedure

The Down-Trend procedure is invoked if the trend is strongly monotonic decreasing. If no position is held, then the Down-Trend process will set the action variable to “Sell” to establish a short position and pass that action to the rest of the system. If a long position is held, then the Down-Trend process will set the action variable to “Sell” to liquidate the long position. If a short position is held, then Down-Trend will evaluate the position to determine if it should be held.

Sideways_Trend Procedure

The Sideways trends are to be avoided if at all possible. The decision algorithms invoked in sideways markets depend strongly on combinations of values and inequality constraints on the control.

Manage & Record Trade Procedure

Each trade has to be managed as to its performance. This procedure invokes stop-loss and take-profit policies that are independent of the policy determine by the curvature of the time-history.

Simulation Results and Draw Down Analyses

The model portfolios described here included ten contracts from each of the currencies, energies, interest rates, grains and oilseeds, stock index futures, meats, metals, and “softs” markets. Included in this paper are results from the stock indices and the currency markets.

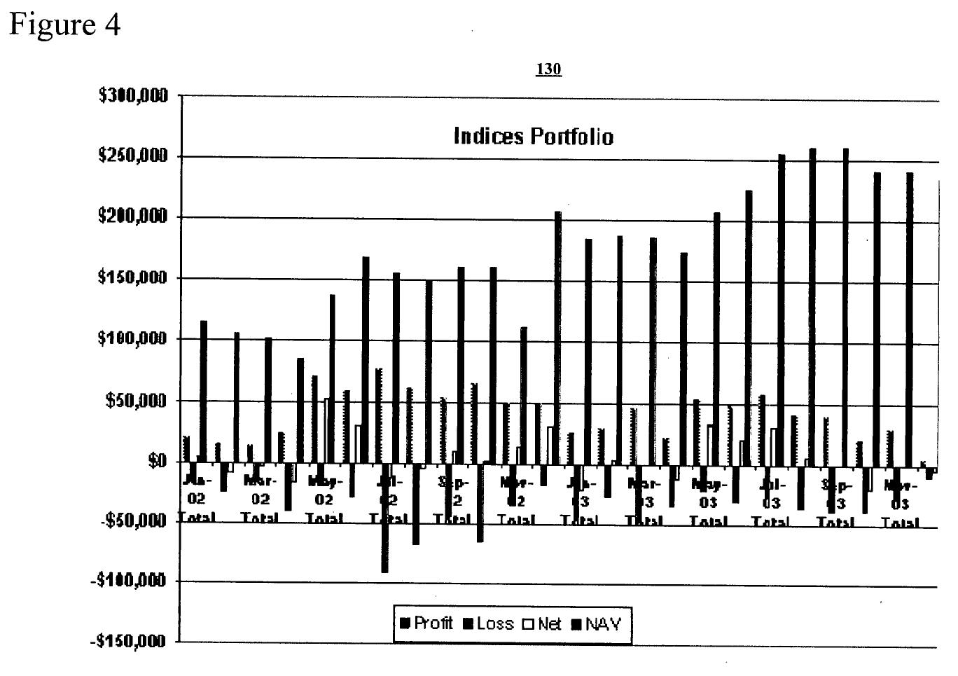

FIG. 4 is a chart 130 illustrating an exemplary monthly profit, loss, net profit and net asset value for a portfolio of one contract of each stock index futures.

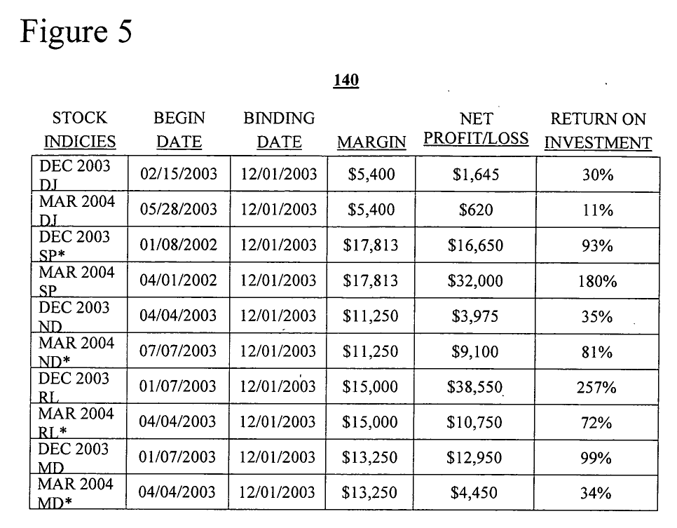

FIG. 5 is a table 140 showing the composition of the stock index portfolio of FIG. 4 with a percentage gain over the entire period of a simulation.

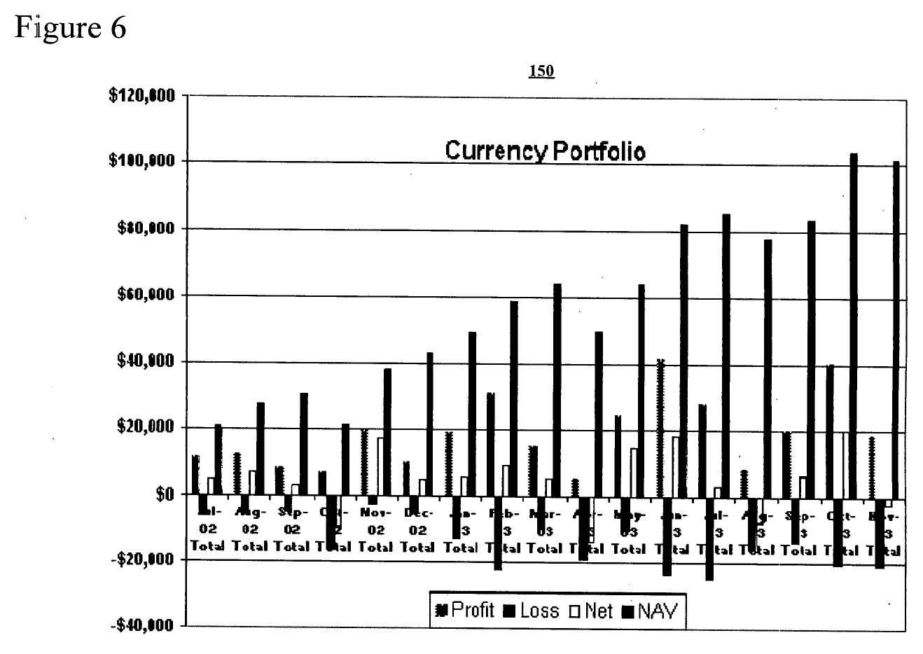

FIG. 6 is a chart 150 illustrating a monthly profit, loss, net profit and net asset value for a portfolio of one contract of an exemplary currency market.

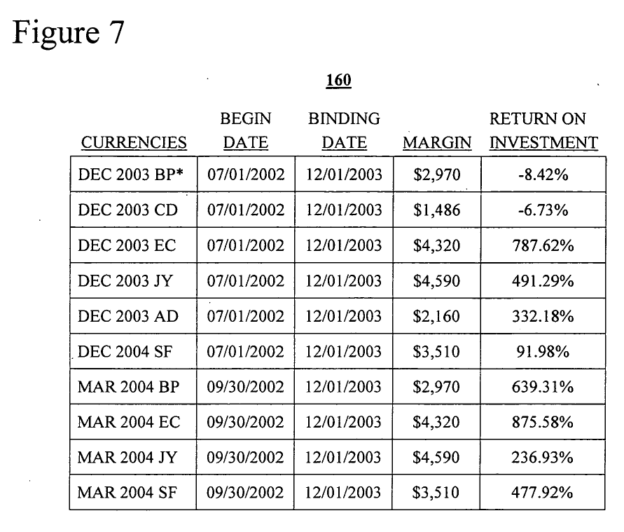

FIG. 7 is a table 160 showing the composition of the currency market portfolio of FIG. 6 with a percentage gain over the entire period of the simulation.

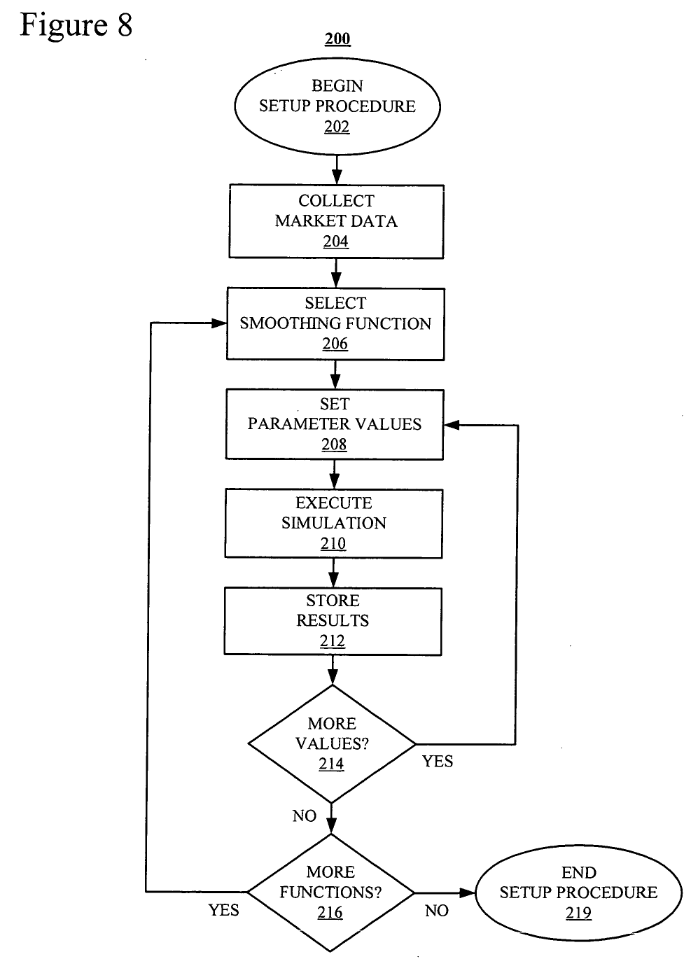

FIG. 8 is a flowchart of a Setup Procedure process 200 that is one, exemplary implementation of the claimed subject matter. Process 200 starts in a “Begin Setup Procedure” block 202 and control proceeds immediately to “Collect Market Data” block 204. During block 204, process 200 collects market information for a selected market with respect to a particular portfolio of investments. Information is collected between a designated start time and a designated end time. Process 200 then proceeds to a “Select Smoothing Function” block 206 during which process 200 selects one of a number of possible smoothing functions with which to process the historical data collected during block 204. Of course, there may only be one smoothing function, or filter, from which to choose. The purpose of the smoothing function is explained above in conjunction with the mathematical considerations.

During a “Set Parameter Values” block 208, process 200 selects the parameters that are employed in conjunction with the smoothing function selected during block 206. An example of a parameter includes, but is not limited to, the number of points to include in any particular sample that the smoothing function operates on at a specific time. Those with skill in the computing and mathematical arts should appreciate that there are many possible parameters that may be modified to change the outcome of any particular smoothing function. During an “Execute Simulation” block 210, process 200 processes the data collected during block 204 with the smoothing function selected during block 206 and the parameters selected during block 208. The results of the execution correspond to the expected gain or loss in the particular portfolio as if the particular smoothing function and parameters had been used to predict potential trades in the portfolio.

During a “Store Results” block 212, process 200 stores in a memory the results of the smoothing function execution during block 210. The results of multiple simulations are later compared to determine the specific smoothing function and parameters that would have maximized profit and minimized risk in the portfolio if the trades had actually occurred. In this manner, employing the best smoothing function and parameters, trading recommendations are made on real-time data.

During a “More Values?” block 214, process 200 determines whether or not a sufficient number of parameter variations have been simulated during block 210. If not, control returns to block 208 during which new parameter values are set and the processing continues as described above. If during block 214 process determines that enough parameter values have been simulated, then control proceeds to a “More Functions?” block 216 during which process 200 determines whether or not there are additional smoothing functions to test. If so, process 200 returns to block 206 and processing continues as describe above. If not, process proceeds to an “End Setup Procedure” block 219 in which process 200 is complete.

As explained above, the results of process 200 are employed to determine a smoothing function and parameters that would maximize profit and minimize risk during the execution on the data collected during block 204. Once this determination is made, then the appropriate smoothing functions and parameters are employed on real-time data to make market recommendations.

Conclusion

It would indeed be wonderful to have a deterministic theory of dynamic market behavior that has the same logical basis and validity as physics. Such a theory is not likely to be developed in the near future. However, the results presented make an extremely strong case for determinism in market behavior.

Several interesting phenomena were observed in these experiments some of which appear to illustrate the counter intuitive behavior characteristic of nonlinear systems. One example of this behavior is that under certain conditions the appropriate decisions are exactly the opposite of what is expected. The condition is corrected by switching the signs on two controls. This behavior requires much more investigation.

The Dow Jones 30 Industrials Index component stocks were also included in several experiments with extremely encouraging results. Further research on the development of automated stock and options research systems is being conducted utilizing clusters of computers. Systems for objective stock research have become necessary because of the illegal or unethical activities in the stock research, investment banking, and mutual funds industries.

Optimal control modules for arbitrage and hedging for manufacturers and wholesalers are being designed. Other commodity risk management software systems being studied include strategic marketing methodologies enhancement; integrate business information systems with market information systems to optimize hedging applications, automatically structure relevant futures contracts and derivatives for risk management strategies to mitigate price exposure for various finished products; and integration of information from public and proprietary sources to minimize existing forward price exposure.

### References

The following documents were referred to in the specification above and are incorporated in their entirety:
Northrop, F. S. C., The Logic of the Sciences and the Humanities, Meridian Books, Inc., New York, 1960, p. 235.
Bodie, Zvi, Alex Kane, and Alan J. Marcus, Investments, Second Edition, Irwin, Chapter 12, Burr Ridge, Ill., 1993.
Chiarella, Carl, “The dynamics of speculative behaviour,” Annals of Operations Research, Special Issue on Nonlinear Methods in Economic Dynamics and Optimal Control, 1992
Takahashi, Yasundo, Michael J. Rabins, and David Auslander, Control and Dynamic Systems, Addison Wesley Publishing Company, Reading, Mass., 1970.
Hildebrand, F. B., Introduction to Numerical Analysis, (McGraw-Hill, Inc, New York, 1956), Dover Publications, 1987.
Protter, Murray and Charles B. Morrey, Jr. Calculus with Analytic Geometry, Addison-Wesley Publishing Company, New York, Chapter 7, 1963.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

1. A method for maximizing profits in a trading portfolio, comprising:
collecting a data set corresponding to a market, wherein the data corresponds to the price of trades in the market between a defined start time and a defined end time;
iteratively execute a first smoothing function on the data set, wherein each time the first smoothing function is executed first parameter values associated with the first smoothing function are modified and results relating to profit maximization and risk minimization corresponding to the modified first parameters values are produced;
selecting from the first parameter values a set of parameter values corresponding to a particular iteration of the first smoothing function based upon the results corresponding to the selected set of first parameter values;
generating a first derivative of the smoothing function with the selected set of first parameter values;
applying the first derivative of the smoothing function to real-time data collected from the market; and
providing a recommendation for a trade in the market based upon results produced by the first derivative of the smoothing function as applied to the real-time data.

2. The method of claim 1, further comprising:
generating a second derivative of the first smoothing function with the selected set of first parameter values;
applying the second derivative of the first smoothing function to real-time data collected from the market; and
providing a recommendation for a trade in the market based upon results of the first and second derivative of the first smoothing function as applied to the real-time data rather that based upon the first derivative function only.

3. The method of claim 1, wherein:
the iteratively executing further comprises iteratively executing a second smoothing function and corresponding parameter values;
the selection includes selecting one of the first or second smoothing function and corresponding set of parameter values; and
generating, applying and providing apply to the selected smoothing function and corresponding parameter values.

4. The method of claim 1, wherein the market is a commodities futures market.

5. The method of claim 1, wherein the market is a stock market.

6. The method of claim 1, wherein the smoothing function is a multi-point moving average.

7. The method of claim 6, wherein the multi-point moving average is a three point linear least squares polynomial filter.

8. A system for maximizing profits in a trading portfolio, comprising:
a data set corresponding to a market, wherein the data corresponds to the price of trades in the market between a defined start time and a defined end time;
a first smoothing function;
a first set of parameters associated with the first smoothing function;
logic for iteratively executing the first smoothing function on the data set, wherein each time the first smoothing function is executed values corresponding to the first set of parameters are modified and results relating to profit maximization and risk minimization corresponding to the modified first parameters values are produced;
logic for selecting from the values a set of parameter values corresponding to a particular iteration of the first smoothing function based upon the results corresponding to the selected set of first parameter values;
logic for generating a first derivative of the smoothing function with the selected set of first parameter values;
logic for applying the first derivative of the smoothing function to real-time data collected from the market; and
logic for providing a recommendation for a trade in the market based upon results produced by the first derivative of the smoothing function as applied to the real-time data.

9. The system of claim 8, further comprising:
logic for generating a second derivative of the first smoothing function with the selected set of first parameter values;
logic for applying the second derivative of the first smoothing function to real-time data collected from the market; and
logic for providing a recommendation for a trade in the market based upon results of the first and second derivative of the first smoothing function as applied to the real-time data rather that based upon the first derivative function only.

10. The system of claim 8, further comprising:
a second smoothing function;
a second set of parameters associated with the second smoothing function; wherein
the logic for iteratively executing further comprises logic for iteratively executing the second smoothing function and corresponding parameter values;
the logic for selecting comprises logic for selecting one of the first or second smoothing function and corresponding set of parameter values; and
the logic for generating, applying and providing apply to the selected smoothing function and corresponding parameter values.

11. The system of claim 8, wherein the market is a commodities futures market.

12. The system of claim 8, wherein the market is a stock market.

13. The system of claim 8, wherein the smoothing function is a multi-point moving average.

14. The system of claim 13, wherein the multi-point moving average is a three point linear least squares polynomial filter.

15. A computer programming product for maximizing profits in a trading portfolio, comprising:
a memory;
logic, stored on the memory, for collecting a data set corresponding to a market, wherein the data corresponds to the price of trades in the market between a defined start time and a defined end time;
logic, stored on the memory, for iteratively execute a first smoothing function on the data set, wherein each time the first smoothing function is executed first parameter values associated with the first smoothing function are modified and results relating to profit maximization and risk minimization corresponding to the modified first parameters values are produced;
logic, stored on the memory, for selecting from the first parameter values a set of parameter values corresponding to a particular iteration of the first smoothing function based upon the results corresponding to the selected set of first parameter values;
logic, stored on the memory, for generating a first derivative of the smoothing function with the selected set of first parameter values;
logic, stored on the memory, for applying the first derivative of the smoothing function to real-time data collected from the market; and
logic, stored on the memory, for providing a recommendation for a trade in the market based upon results produced by the first derivative of the smoothing function as applied to the real-time data.

16. The computer programming product of claim 15, further comprising:
logic, stored on the memory, for generating a second derivative of the first smoothing function with the selected set of first parameter values;
logic, stored on the memory, for applying the second derivative of the first smoothing function to real-time data collected from the market; and
logic, stored on the memory, for providing a recommendation for a trade in the market based upon results of the first and second derivative of the first smoothing function as applied to the real-time data rather that based upon the first derivative function only.

17. The computer programming product of claim 15, wherein:
the iteratively executing further comprises iteratively executing a second smoothing function and corresponding parameter values;
the selection includes selecting one of the first or second smoothing function and corresponding set of parameter values; and
generating, applying and providing apply to the selected smoothing function and corresponding parameter values.

18. The computer programming product of claim 15, wherein the market is a commodities futures market.

19. The computer programming product of claim 15, wherein the market is a stock market.

20. The computer programming product of claim 15, wherein the multi-point moving average is a three point linear least squares polynomial filter.
